(19) United States
(12) Patent Application Publication
(10) Pub. No.: US 2026/0194215 A1
(43) Pub. Date: Jul. 9, 2026

(54) BREAKAWAY TRANSFORMER BASE

(71) Applicant: Pelco Products, Inc., Edmond, OK (US)

(72) Inventors: Kennith E. George, Edmond, OK (US); Angela R. Stussi, Edmond, OK (US)

(21) Appl. No.: 19/097,315

(22) Filed: Apr. 1, 2025

Related U.S. Application Data
(60) Provisional application No. 63/743,139, filed on Jan. 8, 2025.

(51) Int. Cl. F21V 21/10; F21S 8/08

(52) U.S. Cl. CPC F21V 21/10; F21S 8/085

(57) ABSTRACT

A transformer base for a utility pole has a housing and a cover panel. The housing has a bottom with a planar surface and a plurality of openings to receive an anchoring system to anchor the housing to a foundation, a top connectable to the utility pole, and a sidewall extending from the bottom to the top, an exterior surface, an interior surface with the interior surface defining a hollow cavity, and an access opening extending through the sidewall and having a first side edge, a second side edge, a top edge, and a bottom edge. The cover panel is removably connected to the housing to close the access opening. The sidewall has a frangible line extending circumferentially along the sidewall such that the sidewall of the housing fails in the event of a moment of force being applied to the top of the housing.

### CROSS-REFERENCE TO RELATED APPLICATIONS

This application claims the benefit of U.S. Provisional Application No. 63/743,139, filed Jan. 8, 2025, which is hereby incorporated herein by reference in its entirety.

### BACKGROUND

Transformer bases are mounting structures designed to secure a light pole (also known as a luminaire) to the ground while providing additional functionality, such as housing electrical components. The transformer base serves as a sturdy foundation for the light pole. It is bolted or anchored to a concrete footing installed below ground. The light pole is attached to the top of the transformer base. The transformer base elevates the light pole slightly above ground level, providing clearance for the electrical connections and protecting the pole from damage due to vehicles, water, or corrosion. The transformer base often includes a hollow cavity where electrical components like wiring, fuses, and sometimes transformers are stored. This design protects these components from weather and vandalism while providing easy access for maintenance through a removable cover panel.

The U.S. Department of Transportation Federal Highway Administration (FHWA) reports that roadway departures (RwDs) lead to tens of thousands of highway deaths yearly. This number accounts for approximately 50% of all traffic fatalities. Moreover, the nighttime fatality rate for all collisions is three times the daytime rate. Though the FHWA's research indicates that continuous highway lighting is a proven safety benefit, massive luminaires towering along highways pose a risk for RwD collisions.

To reduce RwD crash severity, the FHWA has created guidelines for transformer bases. Under these guidelines, a transformer base encountering a vehicular collision should readily activate in a predictable manner by breaking away, fracturing, or yielding. While safety concerns dictate that frangible bases consistently break away in a predictable manner upon critical vehicular impact, transformer bases must also be constructed to adequately withstand wind loads and support the weight of the poles, which may extend 40-50 feet high.

The prior art designs predominately involve a base comprised of two or more pieces welded together. One particular prior art base is a two-piece configuration in which the inferred frangibility point is the weld location between the top and bottom sections of the base. A significant problem with breakaway bases of the prior art is their failure to sufficiently break upon critical impact. An additional problem of the prior art transformer bases is the failure to break away in a predictable location and configuration.

### BRIEF DESCRIPTION OF THE DRAWINGS

FIG. 1 is a perspective view of a transformer base constructed in accordance with the inventive concepts disclosed herein with a utility pole connected thereto.

FIG. 2 is an exploded perspective view of the transformer base and utility pole of FIG. 1.

FIG. 3 is a perspective view of a housing of the transformer base.

FIG. 4 is a sectional view taken along line 4-4 of FIG. 3.

FIG. 5 is a sectional view taken along line 5-5 of FIG. 3.

FIG. 6 is a sectional view taken along line 6-6 of FIG. 3.

FIG. 7 is an enlarged sectional view taken along circle 7 of FIG. 5.

FIG. 8 is a perspective view of another embodiment of a housing of a transformer base.

FIG. 9 is a sectional view of another embodiment of a housing of a transformer base.

### DETAILED DESCRIPTION OF EXEMPLARY EMBODIMENTS

Before explaining at least one embodiment of the inventive concepts disclosed herein in detail, it is to be understood that the inventive concepts are not limited in their application to the details of construction, experiments, exemplary data, and/or the arrangement of the components set forth in the following description, or illustrated in the drawings. The presently disclosed and claimed inventive concepts are capable of other embodiments or of being practiced or carried out in various ways. Also, it is to be understood that the phraseology and terminology employed herein are for the purpose of description only and should not be regarded as limiting in any way.

In the following detailed description of embodiments of the inventive concepts, numerous specific details are set forth in order to provide a more thorough understanding of the inventive concepts. However, it will be apparent to one of ordinary skill in the art that the inventive concepts within the disclosure may be practiced without these specific details. In other instances, well-known features have not been described in detail to avoid unnecessarily complicating the instant disclosure.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, the use of “a” or “an” is employed to describe elements and components of the embodiments herein. This is done merely for convenience and to give a general sense of the inventive concepts. This description should be read to include one or at least one, and the singular should also include the plural unless it is obvious that it is meant otherwise.

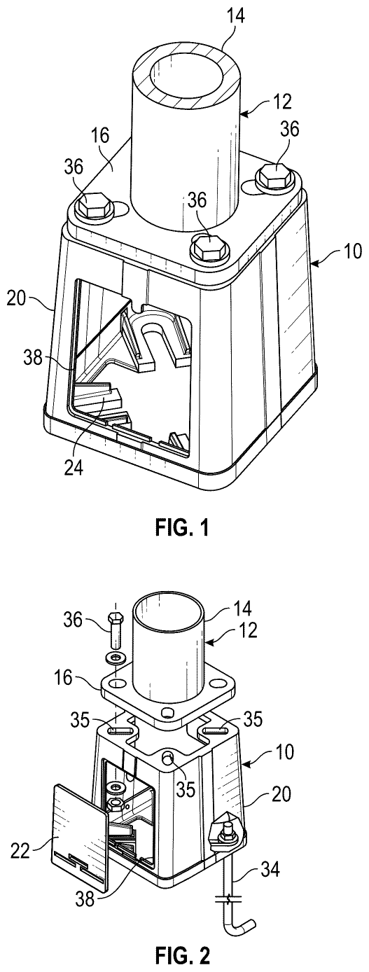

Referring now to the drawings, and more particularly to FIGS. 1 and 2, a transformer base 10 is shown supporting a utility pole 12. As used herein, “utility pole” means a pole, column, post, pipe, or other vertical support member for lighting or traffic control devices, including but not limited to lighting fixtures, luminaires, pedestrian pushbuttons, and other crosswalk control devices, and electrical and/or fiber optic cables, and the like. The utility pole 12 has a pole shaft 14 and a base 16. It will be appreciated that the pole shaft 14 may vary in height and diameter. For example, the pole shaft 14 may extend to a height of forty to sixty feet when supported by the transformer base 10.

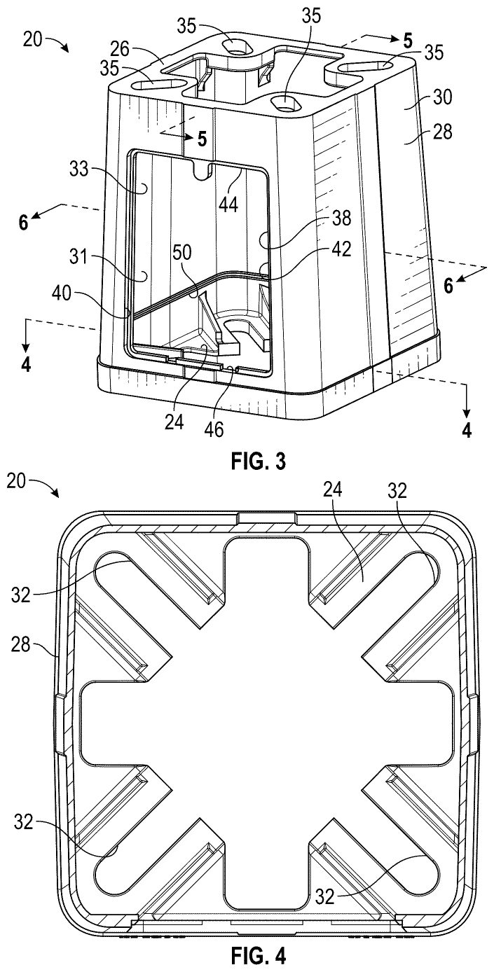

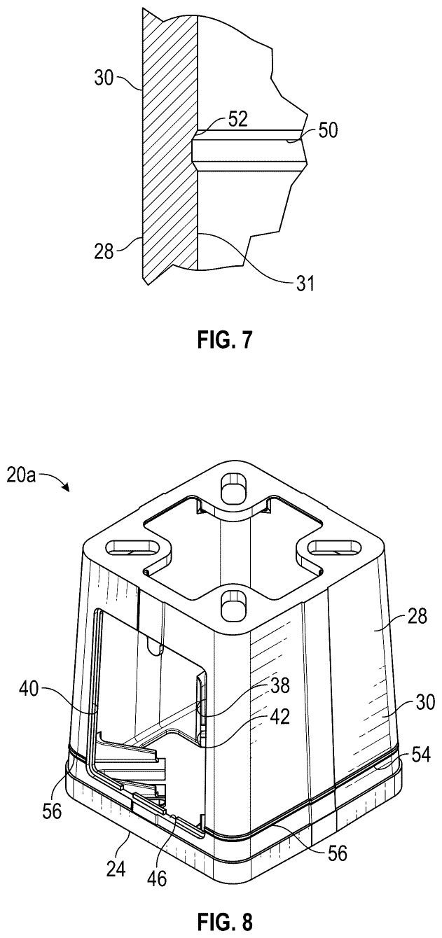

Broadly, the transformer base 10 includes a housing 20 and a cover panel 22 (FIG. 2). Referring to FIGS. 3-7, the housing 20 has a bottom 24, a top 26, and a sidewall 28 extending between the bottom 24 and the top 26. The housing 20 has an exterior surface 30 and an interior surface 31 with the interior surface 31 defining a hollow cavity 33. The housing 20 forms an enclosure and may have any suitable shape and size, depending on the application.

The bottom 24 may be configured in a known manner, with a planar surface extending inwardly from the sidewall 28 for attachment to a foundation, such as a concrete footing (not shown). The bottom 24 may have a plurality of slots or openings 32 for connecting the housing 24 to a plurality of anchors 34 (only one depicted in FIG. 2) extending from the foundation. Similarly, the top 26 may be configured in a known manner. In one embodiment, the top 26 has a planar surface extending inwardly from the sidewall 28 for attachment to the base 16 of the utility pole 12. The top 26 may have a plurality of slots or openings 35 for connecting the base 16 to the top 26 of the housing 24 with a plurality of fasteners 36 (FIG. 2), such as nut and bolt combinations. In other embodiments, the utility pole 12 may be connected to the top 26 by a fit/slip mount connection, a threaded connection, a welded connection, or the like.

The housing 20 may be made of any suitable material, including but not limited to aluminum, plastic, steel, fiberglass, other metals, alloys, solid materials, or a combination. The housing 20 may be cast or otherwise formed as a monolithic unit.

An access opening 38 may be formed in the sidewall 28 of the housing 20. The aspect having the access opening 38 may be designated as the front. The access opening 38 extends through the sidewall 28 and has a first side edge 40, a second side edge 42, a top edge 44, and a bottom edge 46. The cover panel 22 (FIG. 2) is provided to cover the access opening 38. A lock or other mechanism (not shown) may be included in the access panel 22 to prevent vandalism or unauthorized access to the inside of the housing 20. The cover panel 22 may be made of any suitable material, including but not limited to aluminum, plastic, steel, fiberglass, other metals, alloys, solid materials, or a combination. The cover panel 22 may be formed of the same material as the housing 20 or a different material.

The sidewall 28 has a frangible or breakaway line 50 extending circumferentially along the sidewall 28 such that the sidewall 28 of the housing 20 fails in the event of a moment of force being applied to the top 26 of the housing 20, such as when a vehicle impacts the pole shaft 14. As used herein, “frangible” or “breakaway” means constructed to yield or break. This prevents more serious damage to the vehicle and surrounding structures and reduces the likelihood of serious personal injuries to passengers.

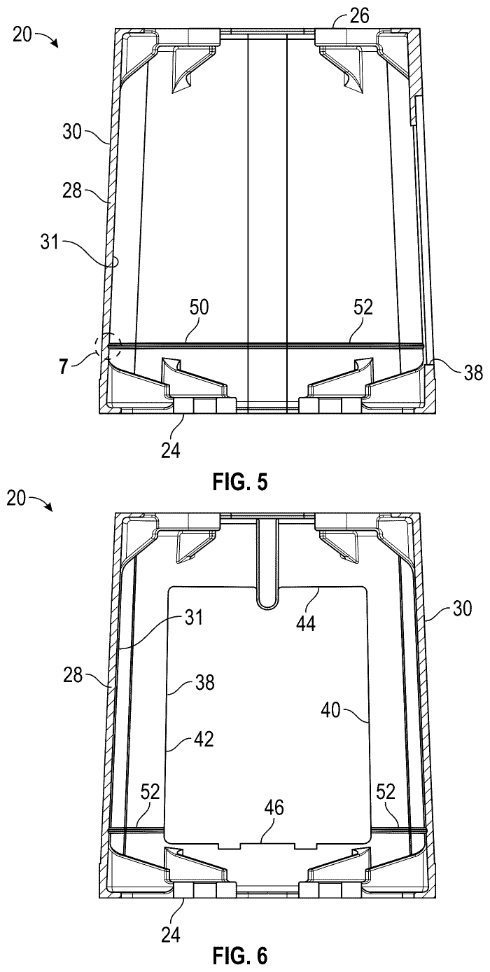

In one embodiment and with reference to FIGS. 5-7, the frangible line 50 is a groove 52 extending along the interior surface 31 of the sidewall 28. The groove 52 may be formed to extend parallel to the bottom 24 of the housing 20, and the groove 52 may be formed along any part of the sidewall 28. In one embodiment, the groove 52 is formed less than four inches from the bottom 24 of the housing 20 due to part of the MASH pass criteria is minimizing damage to the underside of a vehicle. In one embodiment, the groove 52 is formed in the interior surface 31 three inches above the bottom 24 of the housing 20. As best shown in FIG. 6, in one embodiment, one end of the groove 52 intersects the first side edge 40 of the access opening 38, and another end of the groove 52 intersects the second side edge 42 of the access opening 38. To take advantage of the stress risers formed at the intersections of the first side edge 40 and the second side edge 42 with the lower edge 46, the groove 52 may intersect the first side edge 40 and the second side edge 42, near the lower edge 46 of the access opening 38.

The dimensions of the groove 52 may vary depending on the load requirements of the transformer base 10 and the material used to form the housing 20. In one embodiment, the housing 20 may be formed of aluminum 356-T6 with the sidewall 28 having a thickness of about 0.30 inches and the groove 52 having a depth of about 0.030 inches and a width of about 0.125 inches. The groove 52 may also be formed in various configurations. In one embodiment, the groove 52 may be chamfered or beveled with 45-degree edges.

While the frangible line 50 has been described as extending along the interior surface 31 of the sidewall 28, it will be appreciated that in another embodiment of a housing 20a, a frangible line 54 may be formed to extend along the exterior surface 30 of the sidewall 28, as illustrated in FIG. 8. The frangible line 54 is a groove 56 extending along the exterior surface 30 of the sidewall 28. The groove 56 may be formed to extend parallel to the bottom 24 of the housing 20a, and the groove 56 may be formed along any part of the sidewall 28. In one embodiment, the groove 56 is formed less than four inches from the bottom 24 of the housing 20a due to part of the MASH pass criteria is minimizing damage to the underside of a vehicle. In one embodiment, the groove 56 is formed in the exterior surface 30 three inches above the bottom 24 of the housing 20a. In one embodiment, one end of the groove 56 intersects the first side edge 40 of the access opening 38, and another end of the groove 56 intersects the second side edge 42 of the access opening 38. To take advantage of the stress risers formed at the intersections of the first side edge 40 and the second side edge 42 with the lower edge 46, the groove 56 may intersect the first side edge 40 and the second side edge 42 near the lower edge 46 of the access opening 38.

The dimensions of the groove 56 may vary depending on the load requirements of the transformer base 10 and the material used to form the housing 20a. In one embodiment, the housing 20a may be formed of aluminum 356-T6, with the sidewall 28 having a thickness of about 0.30 inches and the groove 52 having a depth of about 0.030 inches and a width of about 0.125 inches. The groove 52 may also be formed in various configurations. The groove 56 may be chamfered or beveled with 45-degree edges in one embodiment.

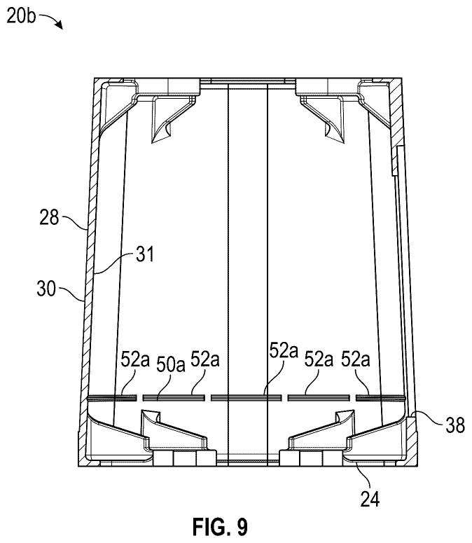

Referring to FIG. 9, another embodiment of a housing 20b is illustrated. The housing 20b is similar to the housing 20, except as described below. The sidewall 28 of the housing 20b has a frangible or breakaway line 50a extending circumferentially along the sidewall 28 such that the sidewall 28 of the housing 20b fails in the event of a moment of force being applied to the top 26 of the housing 20b, such as when a vehicle impacts the pole shaft 14.

In one embodiment, the frangible line 50a is a plurality of grooves 52a spaced longitudinally and extending along the interior surface 31 of the sidewall 28 in a perforation pattern. The plurality of grooves 52a may be formed to extend parallel to the bottom 24 of the housing 20b, and the grooves 52a may be formed along any part of the sidewall 28. In one embodiment, the grooves 52a are formed less than four inches from the bottom 24 of the housing 20b due to part of the MASH pass criteria is minimizing damage to the underside of a vehicle. In one embodiment, the frangible line 50a is formed in the interior surface 31, three inches above the bottom 24 of the housing 20a. In one embodiment, one end of one of the grooves 52a intersects the first side edge 40 of the access opening 38, and one end of another of the grooves 52a intersects the second side edge 42 of the access opening 38. To take advantage of the stress risers formed at the intersections of the first side edge 40 and the second side edge 42 with the lower edge 46, the groove 52a may intersect the first side edge 40 and the second side edge 42, near the lower edge 44 of the access opening 38.

The dimensions of the grooves 52a may vary depending on the load requirements of the transformer base 10 and the material used to form the housing 20b. In one embodiment, the housing 20b may formed of aluminum 356-T6, with the sidewall 28 having a thickness of about 0.30 inches and the grooves 52a having a depth of about 0.030 inches and a width of about 0.125 inches. The grooves 52 a may also be formed in various configurations. In one embodiment, the grooves 52a may be chamfered or beveled with 45-degree edges.

While the grooves 52a has been described as extending along the interior surface 31 of the sidewall 28, it will be appreciated that in some embodiments, the grooves 52a may be formed to extend along the exterior surface 30 of the sidewall 28.

From the above description, it is clear that the inventive concepts disclosed and claimed herein are well adapted to carry out the objects and to attain the advantages mentioned herein, as well as those inherent in the invention. While exemplary embodiments of the inventive concepts have been described for purposes of this disclosure, it will be understood that numerous changes may be made that will readily suggest themselves to those skilled in the art and which are accomplished within the spirit of the inventive concepts disclosed and/or defined in the appended claims.

What is claimed is:

1. A transformer base for a utility pole, comprising:
a housing having a bottom with a planar surface and a plurality of openings to receive an anchoring system to anchor the housing to a foundation, a top connectable to the utility pole, and a sidewall extending from the bottom to the top, an exterior surface, an interior surface with the interior surface defining a hollow cavity, and an access opening extending through the sidewall and having a first side edge, a second side edge, a top edge, and a bottom edge; and
a cover panel removably connected to the housing to close the access opening,
wherein the sidewall has a frangible line extending circumferentially along the sidewall such that the sidewall of the housing fails in the event of a moment of force being applied to the top of the housing.

2. The base of claim 1, wherein the frangible line is a groove extending along the interior surface of the housing.

3. The base of claim 2, wherein the groove extends parallel to the bottom of the housing.

4. The base of claim 3, wherein one end of the groove intersects the first side edge of the access opening, and another end of the groove intersects the second side edge of the access opening.

5. The base of claim 1, wherein one end of the frangible line intersects the first side edge of the access opening, and another end of the frangible line intersects the second side edge of the access opening.

6. The base of claim 1, wherein the frangible line is a groove extending along the exterior surface of the housing.

7. The base of claim 1, wherein the housing is monolithic.

8. The base of claim 7, wherein the housing is comprised of an aluminum alloy.

9. The base of claim 1, wherein the frangible line is a plurality of grooves spaced apart and extending along one of the interior surface and the exterior surface of the housing.

10. The base of claim 9, wherein the plurality of grooves defines a perforation pattern parallel to the bottom of the housing.

11. The base of claim 1, wherein the frangible line is spaced from the bottom in a range from 0.10 inches to 4.0 inches.

12. A transformer base in combination with a utility pole, the transformer base comprising:
a housing having a bottom with a planar surface and a plurality of openings to receive an anchoring system to anchor the housing to a foundation, a top connected to the utility pole, and a sidewall extending from the bottom to the top, an exterior surface, an interior surface with the interior surface defining a hollow cavity, and an access opening extending through the sidewall and having a first side edge, a second side edge, a top edge, and a bottom edge; and
a cover panel removably connected to the housing to close the access opening,
wherein the sidewall has a frangible line extending circumferentially along the sidewall such that the sidewall of the housing fails in the event of a moment of force being applied to the top of the housing.

13. The combination of claim 12, wherein the frangible line is a groove extending along the interior surface of the housing.

14. The combination of claim 13, wherein the groove extends parallel to the bottom of the housing.

15. The combination of claim 14, wherein one end of the groove intersects the first side edge of the access opening, and another end of the groove intersects the second side edge of the access opening.

16. The combination of claim 12, wherein one end of the frangible line intersects the first side edge of the access opening, and another end of the frangible line intersects the second side edge of the access opening.

17. The base of claim 12, wherein the frangible line is a groove extending along the exterior surface of the housing.

18. The combination of claim 12, wherein the housing is monolithic.

19. The combination of claim 18, wherein the housing is comprised of an aluminum alloy.

20. The combination of claim 12, wherein the frangible line is a plurality of grooves spaced apart and extending along one of the interior surface and the exterior surface of the housing.

21. The combination of claim 20, wherein the plurality of grooves defines a perforation pattern parallel to the bottom of the housing.

22. The combination of claim 12, wherein the frangible line is spaced from the bottom in a range from 0.10 inches to 4.0 inches.
